(19) United States
(12) Patent Application Publication
(10) Pub. No.: US 2017/0211683 A1
(43) Pub. Date: Jul. 27, 2017

(54) SYSTEMS AND METHODS FOR PROVIDING LUBRICATION

(71) Applicants: Christopher Rogers, Oak Harbor, WA (US); Jacob Wiederspohn, Oak Harbor, WA (US)

(72) Inventors: Christopher Rogers, Oak Harbor, WA (US); Jacob Wiederspohn, Oak Harbor, WA (US)

(21) Appl. No.: 15/008,370

(22) Filed: Jan. 27, 2016

(51) Int. Cl. F16H 57/04; B05B 9/01

(52) U.S. Cl. CPC F16H 57/046; F16H 57/0436; B05B 9/01

(57) ABSTRACT

A pump system designed to provide targeted lubrication to gears and gear trains. Comprised essentially of a pump and a sprayer. May include multiple sprayers to target multiple gears. May include intake system to allow reuptake of lubrication. May be adjustable to change location of target, flow rate or force of lubricant, or diameter of lubricated area. Outflow system may include multiple hoses or a single hose, and may include one or more couplers. Couplers may also serve to divide the lubricant stream into multiple streams to serve multiple sprayers. May include fastener systems for mounting on gear train housings. May be configured to withstand high or low temperatures, and may be configured to adjust temperature of lubricant. May be configured to withstand high vibration environments. May be configured to provide at least some cleaning of lubricant as it flows through the system.

### FIELD OF THE INVENTION

This invention relates generally to gear trains, and, more specifically, to systems and methods for providing lubrication to gear trains.

### BACKGROUND OF THE INVENTION

Gears have long been lubricated with the application of natural and synthetic oils. It should be understood that throughout this application, the word “oil” may be construed to mean natural oil, synthetic oil, or any other lubricant appropriate for application to gear trains. It should also be understood that “oil” and “lubricant” may be used interchangeably throughout this application. If a particular characteristic discussed is unique to a particular type of lubricant, a note to that effect will be made.

Most gears rely on an oil bath to provide lubrication, requiring routine maintenance and checking of the oil levels within a gear train housing. When the gears spin, they throw off the oil from the oil bath, coating the walls of any housing with oil and reducing the efficacy of the lubrication. Moreover, when the oil level falls below a certain level, the only lubrication provided is that which is picked up by the gear teeth at the bottom of the gear's rotation, much of which is thrown off before it ever reaches the mesh point of the gear, leaving the gears to grind and cause wear and damage. These are just some of the problems that the present invention, disclosed in detail herein, aims to overcome.

### SUMMARY OF THE INVENTION

This invention relates generally to gear trains, and, more specifically, to systems and methods for providing lubrication to gear trains.

The present invention is comprised essentially of a pump and at least one sprayer. The pump is designed to collect and put force behind a volume of lubricant. The sprayer is designed to direct the lubricant to targeted locations.

A pump system designed to provide targeted lubrication to gears and gear trains. Comprised essentially of a pump and a sprayer. May include multiple sprayers to target multiple gears. May include intake system to allow reuptake of lubrication. May be adjustable to change location of target, flow rate or force of lubricant, or diameter of lubricated area. Outflow system may include multiple hoses or a single hose, and may include one or more couplers. Couplers may also serve to divide the lubricant stream into multiple streams to serve multiple sprayers. May include fastener systems for mounting on gear train housings. May be configured to withstand high or low temperatures, and may be configured to adjust temperature of lubricant. May be configured to withstand high vibration environments. May be configured to provide at least some cleaning of lubricant as it flows through the system.

In some embodiments, the system for providing lubrication may be comprised of: at least one pump; at least one outflow hose coupled with at least one port on the at least one pump; and at least one sprayer coupled with the at least one outflow hose. In some embodiments, the system may include: at least one inflow hose coupled with at least one port on the at least one pump; and at least one intake valve coupled with the at least one inflow hose. In some embodiments, the at least one sprayer may be coupled with the at least one outflow hose via at least one coupler. In some embodiments, the at least one coupler may be a directional coupler. In some embodiments, the system may include: at least one gear pair, wherein the at least one sprayer may be configured to spray at least some lubricant on the at least one gear pair. In some embodiments, the at least one sprayer configured to spray at least some lubricant on the at least one gear pair may be comprised of: at least one sprayer configured to spray at least some lubricant on the at least one gear pair where the gears intermesh.

In some embodiments, the system for providing lubrication may be comprised of: at least one pump, including at least one outflow port and at least one inflow port; at least one outflow hose including a pump end and a sprayer end, wherein the at least one outflow hose pump end may be coupled with the at least one outflow port of the at least one pump; at least one sprayer coupled with the at least one outflow hose at the sprayer end of the at least one outflow hose; at least one inflow hose including a pump end and an intake end, wherein the at least one inflow hose pump end may be coupled with the at least one inflow port of the at least one pump; and at least one intake valve coupled with the at least one inflow hose at the intake end of the at least one inflow hose. In some embodiments, the at least one sprayer may be adjustable. In some embodiments, the at least one pump may be adjustable. In some embodiments, the system may be configured for circulating a lubricant through the outflow hose, the sprayer, the intake valve, the inflow hose, and the pump.

In some embodiments, the system for providing lubrication may be comprised of: at least one pump, including at least one outflow port and at least one inflow port; at least one outflow hose, including a pump end and a sprayer end, wherein the at least one outflow hose pump end may be coupled with the at least one outflow port of the at least one pump; a plurality of sprayer hoses, each hose including a pump end and a sprayer end, wherein the plurality of sprayer hose pump ends are coupled with the at least one outflow hose at the sprayer end of the at least one outflow hose; a plurality of sprayers coupled with the plurality of sprayer hoses at the sprayer end of the plurality of sprayer hoses; at least one inflow hose including a pump end and an intake end, wherein the at least one inflow hose pump end may be coupled with the at least one inflow port of the at least one pump; and at least one intake valve coupled with the at least one inflow hose at the intake end of the at least one inflow hose. In some embodiments, the plurality of sprayer hose pump ends coupled with the at least one outflow hose at the sprayer end of the at least one outflow hose may include: at least one coupler, the at least one coupler configured to divide a single stream of liquid into at least two streams of liquid. In some embodiments, the at least one coupler may be configured to be removably coupleable with the at least one outflow hose and the plurality of sprayer hoses. In some embodiments, the plurality of sprayer hose pump ends coupled with the at least one outflow hose at the sprayer end of the at least one outflow hose may include: a plurality of couplers, the plurality of couplers configured to join the at least one outflow hose with the plurality of sprayer hoses. In some embodiments, the plurality of couplers are configured to divide a single stream of liquid into at least two streams of liquid. In some embodiments, the plurality of couplers are configured to be removably coupleable with the at least one outflow hose and the plurality of sprayer hoses.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is an isometric environmental view of one embodiment of the system for providing lubrication.

FIG. 2 is a cutaway isometric environmental view thereof.

FIG. 3 is a cross-sectional environmental view thereof.

FIG. 4 is a detailed view of one embodiment of the system for providing lubrication.

FIG. 5 is a side environmental view thereof.

FIG. 6 is an isometric environmental view thereof.

FIG. 7 is a detailed view of a different embodiment of the system for providing lubrication.

FIG. 8 is a side environmental view thereof.

FIG. 9 is an isometric environmental view thereof.

### DETAILED DESCRIPTION

This invention relates generally to gear trains, and, more specifically, to systems and methods for providing lubrication to gear trains.

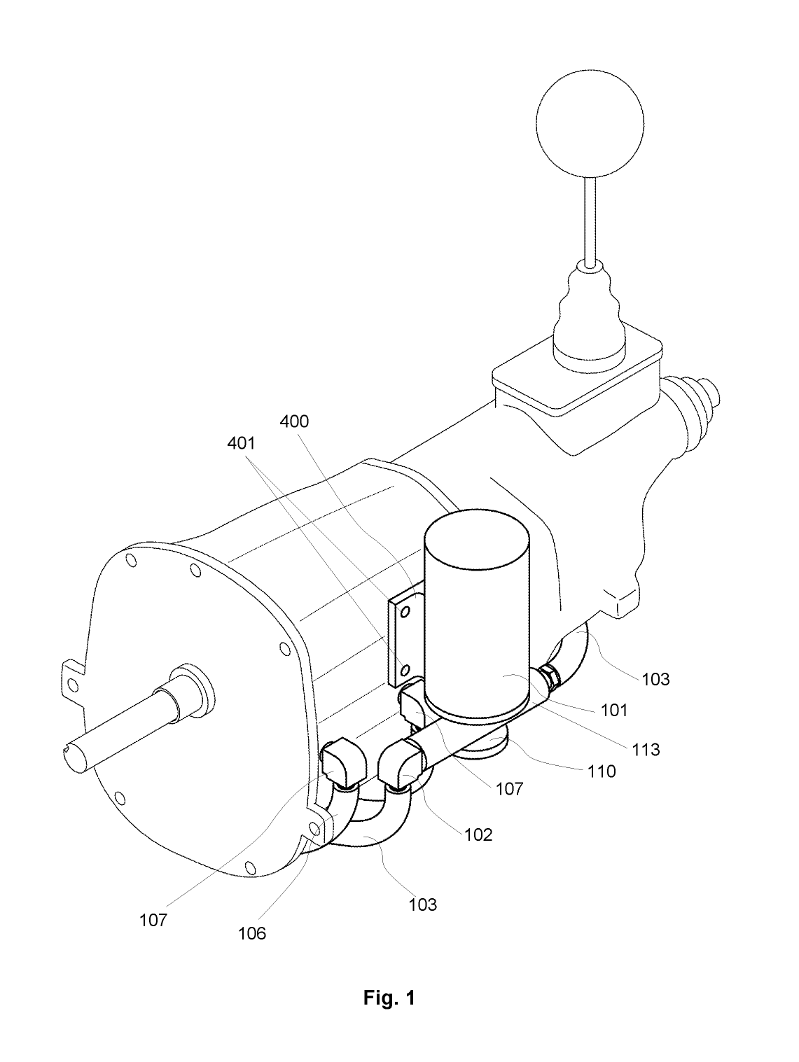

Specific details of certain embodiments of the invention are set forth in the following description and in FIGS. 1-9 to provide a thorough understanding of such embodiments. The present invention may have additional embodiments, may be practiced without one or more of the details described for any particular described embodiment, or may have any detail described for one particular embodiment practiced with any other detail described for another embodiment.

Importantly, a grouping of inventive aspects in any particular “embodiment” within this detailed description, and/or a grouping of limitations in the claims presented herein, is not intended to be a limiting disclosure of those particular aspects and/or limitations to that particular embodiment and/or claim. The inventive entity presenting this disclosure fully intends that any disclosed aspect of any embodiment in the detailed description and/or any claim limitation ever presented relative to the instant disclosure and/or any continuing application claiming priority from the instant application (e.g. continuation, continuation-in-part, and/or divisional applications) may be practiced with any other disclosed aspect of any embodiment in the detailed description and/or any claim limitation. Claimed combinations which draw from different embodiments and/or originally-presented claims are fully within the possession of the inventive entity at the time the instant disclosure is being filed. Any future claim comprising any combination of limitations, each such limitation being herein disclosed and therefore having support in the original claims or in the specification as originally filed (or that of any continuing application claiming priority from the instant application), is possessed by the inventive entity at present irrespective of whether such combination is described in the instant specification because all such combinations are viewed by the inventive entity as currently operable without undue experimentation given the disclosure herein and therefore that any such future claim would not represent new matter.

The present invention is comprised essentially of a pump and at least one sprayer. The pump is designed to collect and put force behind a volume of lubricant. The sprayer is designed to direct the lubricant to targeted locations.

FIG. 1 is an environmental view of one embodiment of the system for providing lubrication. In one embodiment, the system includes a central pump 101. Pump 101 is shown mounted to the wall of a transmission housing with a bracket 400 and fasteners 401. Fasteners 401 may be any time of permanent or semi-permanent fastening mechanism, such as rivets, screws, nuts and bolts, etc. In a preferred embodiment, fasteners 401 would be configured to withstand the elevated temperatures and vibrations that can be associated with gear trains, especially in devices such as motor vehicles. While FIG. 1 depicts the system as mounted on the outside wall of a transmission housing, it should be understood that this system could be deployed on any gear train with different mounting mechanisms, such as a series of brackets, a scaffolding alongside the gear train, or the inside of a clock housing, for some examples.

In some embodiments, pump 101 is coupled with at least one outflow nozzle 102 via outflow valve 113. Outflow nozzle 102 may be a nozzle, it may be a coupler such as a hose coupler, or it may be one of a coupler or nozzle combined with an outflow valve or bracket 113. In some embodiments, outflow valve 113 may be intrinsic to pump 101. In other embodiments, outflow valve 113 may be removably coupleable with pump 101 to assist with cleaning or replacement of system components. In some embodiments, outflow nozzle 102 may be an elbow connector. In other embodiments, outflow nozzle 102 may be a T-connector, a straight line connector, or any other type of connector that allows fluid to pass through it in a controlled or semi-controlled manner. In some embodiments, nozzle 102 may be configured to control fluid flow rates. In other embodiments, nozzle 102 may be configured to pressurize the fluid to provide additional force for spraying. In some embodiments, nozzle 102 may be static. In other embodiments, nozzle 102 may be dynamic, altering the flow rate or pressure of the nozzle on the fluid in order to achieve a higher or lower spray pressure or volume. In further embodiments, nozzle 102 may be automated. In other further embodiments, nozzle 102 may be computer controlled, including the capability of receiving and transmitting signals, wireless signals, or mobile signals. In other further embodiments, nozzle 102 may be manually controlled by a user or operator.

In some embodiments, pump 101 may act as a pump only, drawing up lubricant via intake 110 and directing it outward. In other embodiments, pump 101 may pressurize the lubricant, forcing it out at higher rates, volumes, and/or pressures. In other embodiments, pump 101 may act as a lubricant heater or cooler, adding or withdrawing heat as necessary for optimum performance of the lubricant and gear train. In some embodiments, pump 101 may include a filter or other mechanism by which the lubricant can be cleaned. In some embodiments, pump 101 may be computer controlled to maintain or alter the functions disclosed herein, including the capability of receiving and transmitting signals, wireless signals, or mobile signals. In some embodiments, pump 101 may be static and configured to perform specific functions only. In some embodiments, pump 101 may be manually controlled.

In some embodiments, nozzle 102 may be coupled with outflow hose 103. In some embodiments, outflow hose 103 may be flexible or semi-flexible, such as rubber or other flexible materials. In some embodiments, outflow hose 103 may be more rigid, such as a pipe, to accommodate different environmental factors, such as higher temperatures or unique structures. In some embodiments, outflow hose 103 may be configured to withstand temperatures up to 285 degrees Fahrenheit. In some embodiments, outflow hose 103 may be configured to withstand pressures up to 70 pounds per square inch. In some embodiments, outflow hose 103 may be configured to withstand higher temperatures and pressures, or to increase or decrease at least one of temperature or pressure.

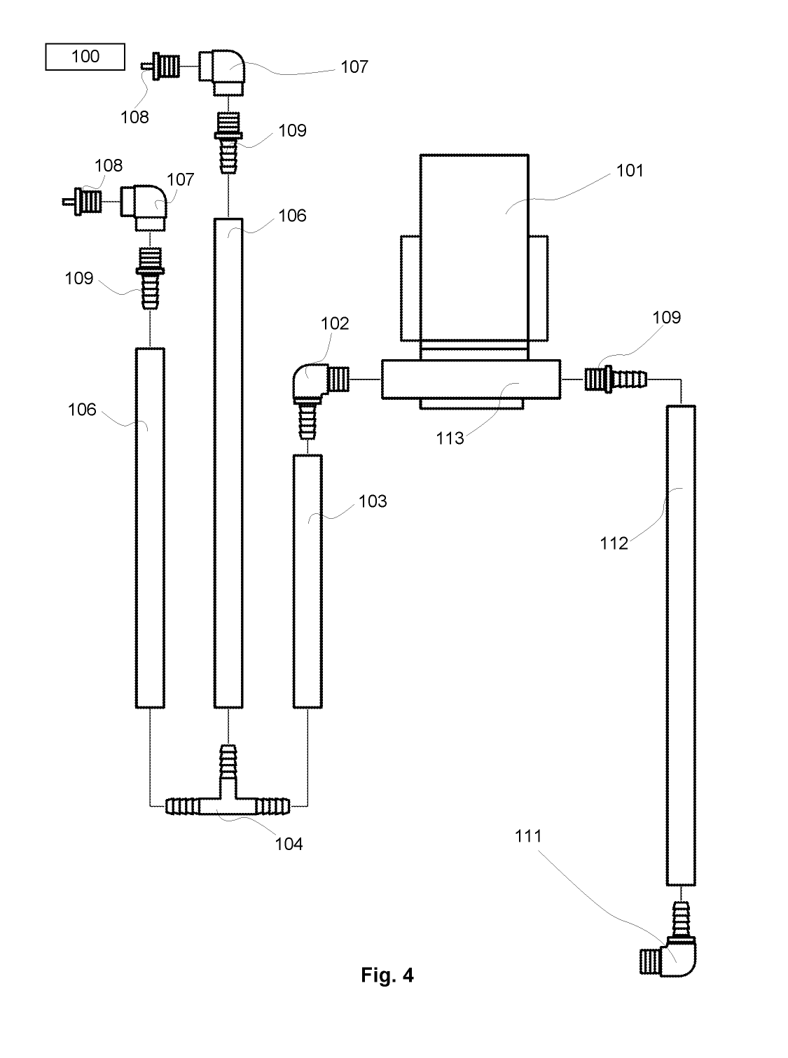

In some embodiments, outflow hose 103 may be coupled with a hose connector 104, shown in FIG. 4, which is not depicted in FIG. 1 because, in some embodiments such as in use on a transmission, it may be mounted to the underside of a gear train housing or in some other inconspicuous location in order to maximize space efficiency. In some embodiments, hose connector 104 may be connected with sprayer hose 106. In some embodiments, sprayer hose 106 may be flexible or semi-flexible, such as rubber or Kevlar® or other flexible materials. In some embodiments, sprayer hose 106 may be more rigid, such as a pipe, to accommodate different environmental factors, such as higher temperatures or unique structures. In some embodiments, sprayer hose 106 may be configured to withstand temperatures up to 285 degrees Fahrenheit. In some embodiments, sprayer hose 106 may be configured to withstand pressures up to 70 pounds per square inch. In some embodiments, sprayer hose 106 may be configured to withstand higher temperatures and pressures, or to increase or decrease at least one of temperature or pressure.

In some embodiments, sprayer hose 106 may be coupled with coupler 107. In the embodiment depicted, coupler 107 is shown as an elbow coupler. In this embodiment, the system is wrapped around the gear train housing, requiring the fluid to change direction as it enters the housing for spraying. In other embodiments, coupler 107 may not be a directional coupler. In some embodiments, coupler 107 may be a hose coupler, or any other means by which a hose or pipe can be coupled with a structure such as a sprayer.

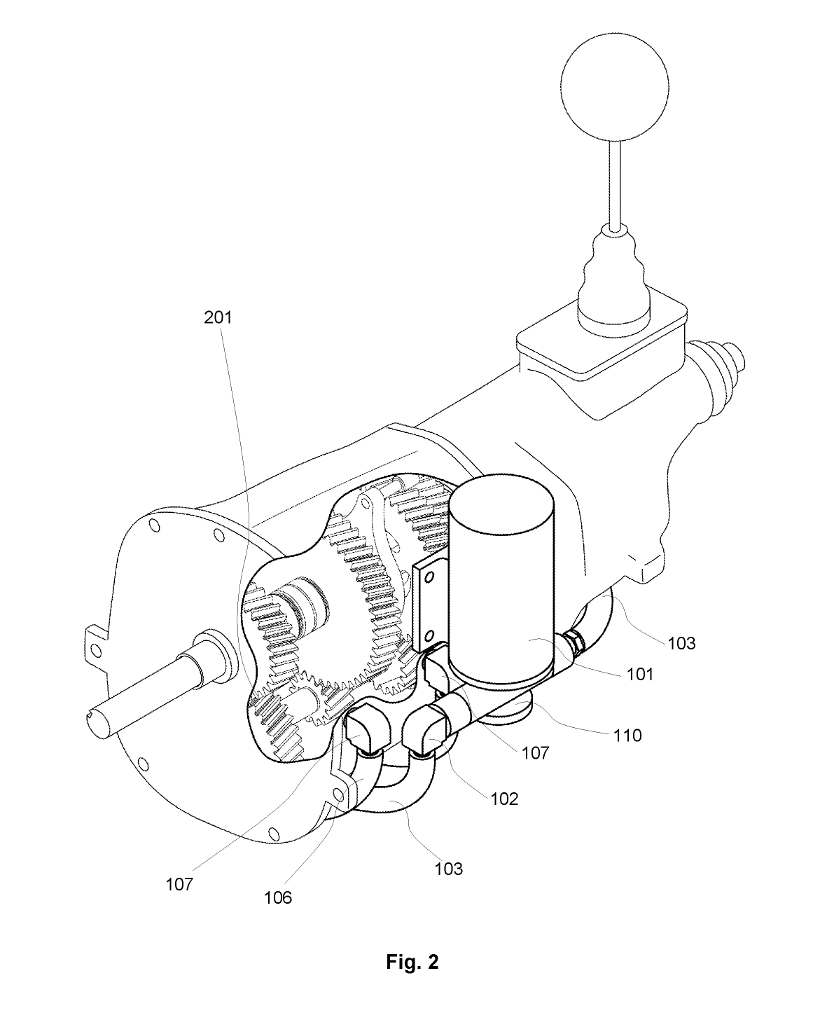

FIG. 2 is a cutaway isometric environmental view of one embodiment of the system for providing lubrication, shown on the housing of a vehicle transmission. The cutaway discloses the gear train within, particularly the gear mesh 201. One purpose of the system is to target lubrication application to particular areas, such as gear mesh 201, as opposed to older systems which rely on the teeth of the gears to pick up and distribute oil from an oil bath. Another purpose of the system is to use intake 110 to draw up oil that has hit the walls and flowed down into the reservoir of the housing, reducing the need for oil baths altogether and allowing for conservation of oil or other lubricants. In an embodiment wherein the system is not mounted on a housing, intake 110 could draw oil or lubricant from another reservoir.

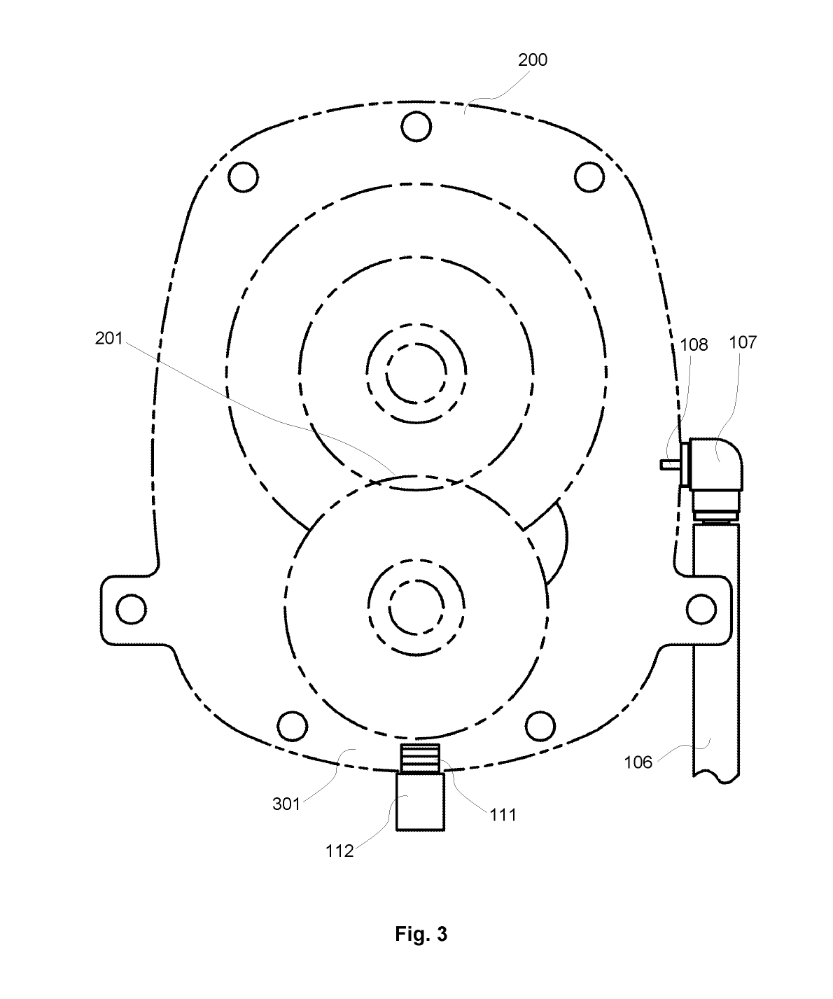

FIG. 3 is a cross-sectional view of one embodiment of the system. In some embodiments, intake valve 111 may be coupled with intake hose 112. In some embodiments, the intake valve 111 may be disposed at the bottom of reservoir 301. Intake valve 111 may be a nozzle, it may be a coupler such as a hose coupler. In some embodiments, intake valve 111 may be an elbow connector. In other embodiments, intake valve 111 may be a T-connector, a straight line connector, or any other type of connector that allows fluid to pass through it in a controlled or semi-controlled manner. In some embodiments, valve 111 may be configured to control fluid flow rates. In other embodiments, valve 111 may be configured to pressurize the fluid to provide additional force for spraying. In some embodiments, valve 111 may be static. In other embodiments, valve 111 may be dynamic, altering the flow rate or pressure of the valve on the fluid in order to achieve a higher or lower spray pressure or volume. In further embodiments, valve 111 may be automated. In other further embodiments, valve 111 may be computer controlled, including the capability of receiving and transmitting signals, wireless signals, or mobile signals. In other further embodiments, valve 111 may be manually controlled by a user or operator.

FIG. 3 also depicts how one embodiment of the system might be disposed on the housing 200. In a preferred embodiment, sprayer 108, which is coupled with sprayer hose 106 via coupler 107, is pointed directly at gear mesh 201 for precise application of lubricant to the area most in need of it. In some embodiments, sprayer 108 may release a targeted stream of lubricant with a small spray diameter. In other embodiments, sprayer 108 may release a mist of lubricant with a large spray diameter. In still other embodiments, sprayer 108 may release a stream of lubricant with a large spray diameter. In other embodiments, sprayer 108 may release a mist of lubricant with a small spray diameter. In other embodiments, sprayer 108 may be adjustable, such that the lubricant coverage is a small or large diameter, as necessary for the application. In another embodiments, sprayer 108 may be adjustable, such that the amount of lubricant released is independent of the diameter of the coverage area. In one non-limiting example, sprayer 108 may be configured to spray the same volume of lubricant over a period of time regardless of the diameter of the coverage area. In some embodiments, sprayer 108 may include a sensor positioned at or near the target area, such sensor configured to determine how much lubricant is present at the target area. In a further embodiment, sprayer 108 may be configured to begin or end a spray based on feedback from the sensor such that optimal lubrication is achieved without wasted lubricant.

FIG. 4 is a detailed view of one embodiment of the system for providing lubrication 100. This embodiment has two sprayers 108, but it should be understood that this system is configurable for one or more gear meshes, and as such may have only one sprayer or a plurality of sprayers. In one embodiment, sprayer 108 may be coupled with coupler 107. In some embodiments, coupler 107 may include hose coupler 109, configured for coupling rigid structures such as elbow couplers with flexible structures such as hoses. In other embodiments, coupler 107 may connect directly with sprayer hose 106. As disclosed in FIG. 1, sprayer hose 106 may be configured to withstand certain temperatures or pressures, or to be more or less flexible based on the particular needs of the particular application. When there is only a single sprayer, connector 104, outflow hose 103, and outflow nozzle 102 may be unnecessary, such that sprayer hose 106 may couple directly with outflow valve 113. In other embodiments, sprayer hose 106 may be coupled with hose connector 104. As shown, connector 104 is a three-way connector, coupling outflow hose 103 with sprayer hoses 106. However, it should be understood that connector 104 could be a single connector with multiple ports, as shown, or it could be a plurality of connectors coupling a plurality of spraying systems.

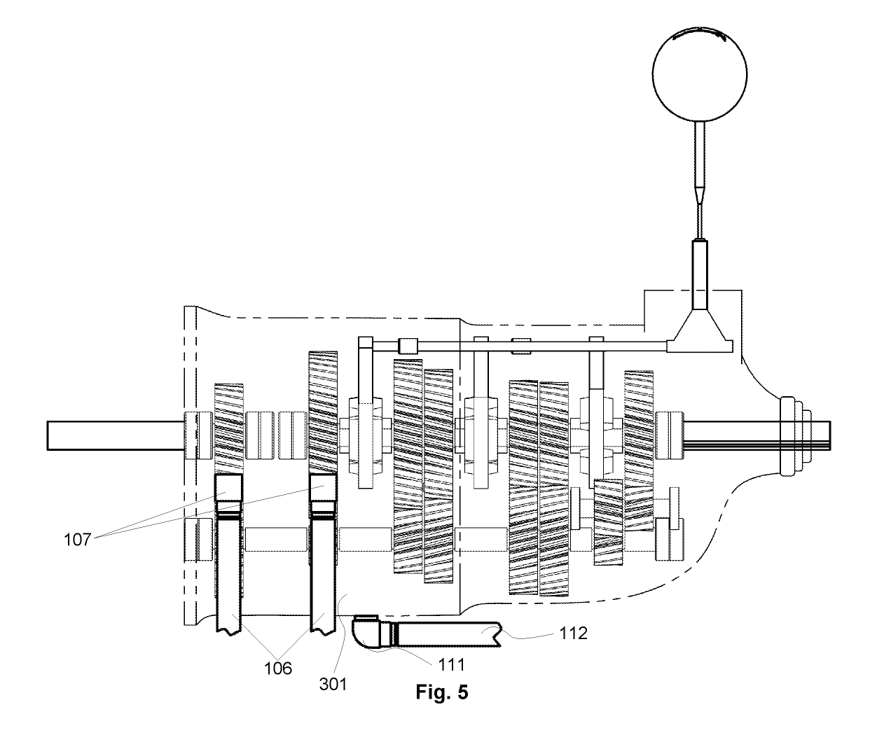

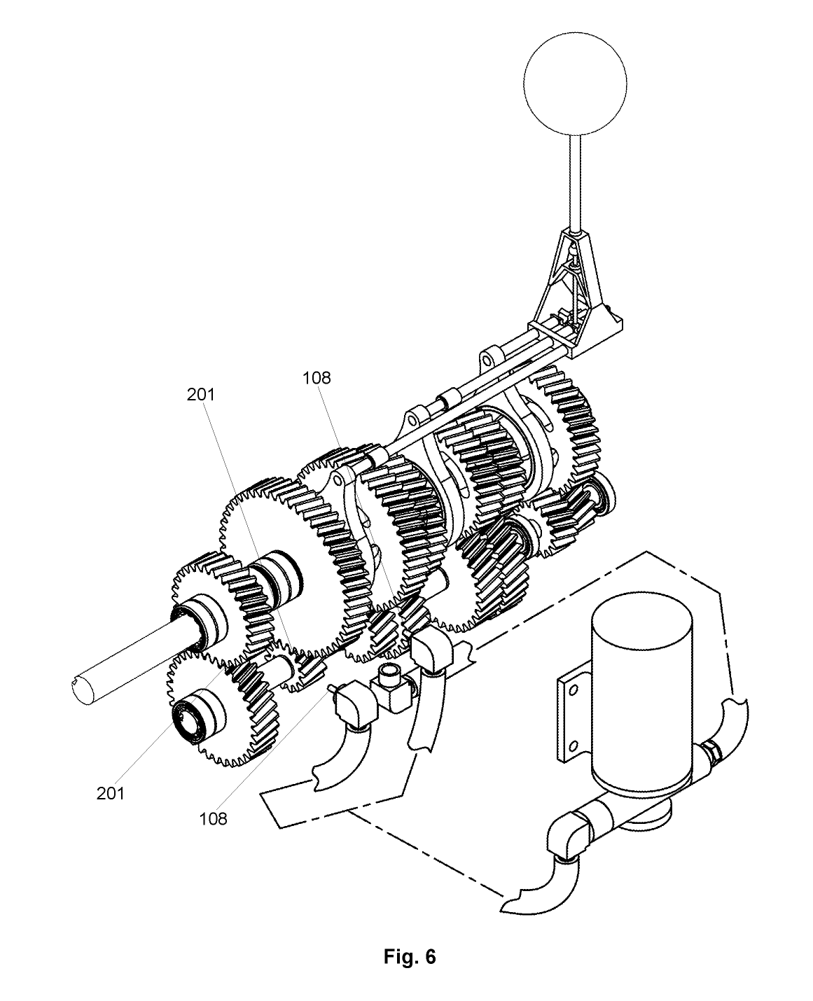

FIG. 4 also depicts one embodiment of the intake system 110, particularly showing intake nozzle 111 and intake hose 112. In some embodiments, intake hose 112 may couple directly with pump 101 via an intake valve (not depicted). In other embodiments, intake hose 112 may couple with pump 101 via hose coupler 109. FIG. 5 is a side environmental view of one embodiment of the two-sprayer system shown in FIG. 4, showing the approximate spatial relationship between sprayer couplers 107 and hoses 106, the gears of the gear train, and the intake valve 111 and hose 112. FIG. 6 is an isometric environmental view showing sprayers 108 pointed at their respective gear meshes 201.

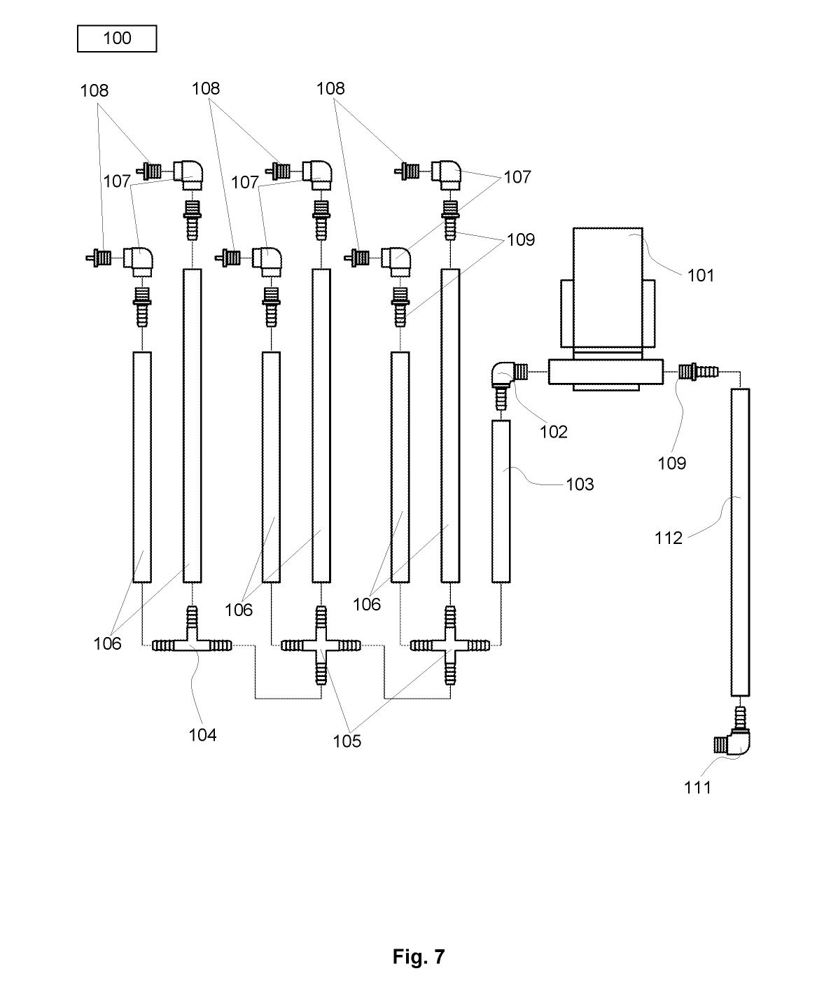

FIG. 7 is a detailed view of one embodiment of the system for providing lubrication 100. This embodiment has four sprayers 108. In one embodiment, sprayer 108 may be coupled with coupler 107. In some embodiments, coupler 107 may include hose coupler 109, configured for coupling rigid structures such as elbow couplers with flexible structures such as hoses. In other embodiments, coupler 107 may connect directly with sprayer hose 106. As disclosed in FIG. 1, sprayer hose 106 may be configured to withstand certain temperatures or pressures, or to be more or less flexible based on the particular needs of the particular application. In some embodiments, sprayer hose 106 may be coupled with hose connector 104. Here it can be seen that, when the system has a plurality of sprayers, connector 104 may actually be a system of connectors. In one embodiment, shown, the connector system consists of the three-way connector 104 as shown in FIG. 4, as well as two four-way connectors 105. This allows six sprayer hoses 106 to be coupled with outflow hose 103. It should be understood that this is illustrative only, and that more or fewer sprayers 108 and hoses 106 could be used, depending on the particular needs of the particular application. In such a system, it may be important to scale outflow nozzle 102, outflow hose 103, pump 101, and intake nozzle 111, hose 112, and coupler 109 in order to maintain sufficient flow and pressure through each of the several sprayers.

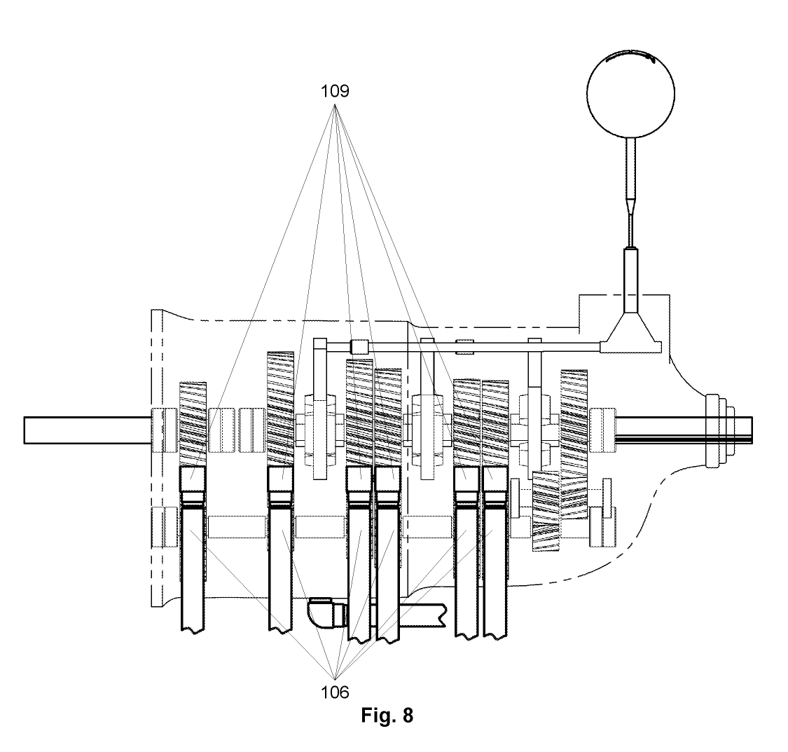

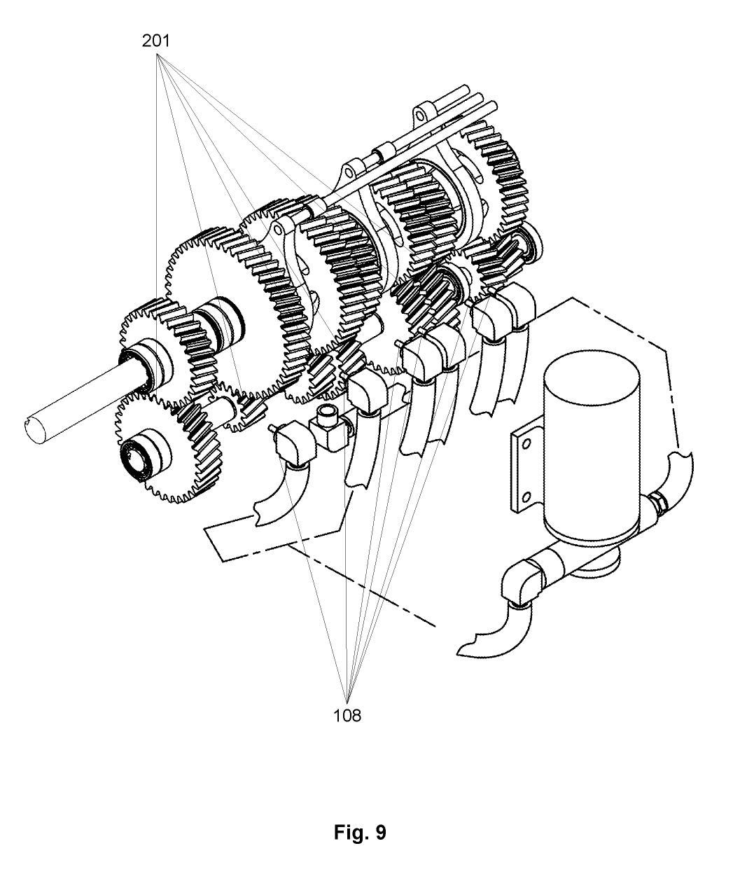

FIG. 8 is a side environmental view of one embodiment of the six-sprayer system shown in FIG. 7, showing the approximate spatial relationship between sprayer couplers 107, hoses 106, and the gears of the gear train. FIG. 9 is an isometric environmental view showing all six sprayers 108 pointed at their respective gear meshes 201.

One non-limiting demonstrative use of the system for providing lubrication is to mount the system on a transmission housing for a motor vehicle. The system may be mounted such that sprayers are directed toward the gear interfaces of at least one gear couplet. There may be as many sprayers as there are gear couplets, such that each gear couplet is sprayed by an individual sprayer. In other embodiments, one sprayer may be configured to spray multiple couplets, or the sprayer may only be targeted to a particularly critical gear. The system may spray lubricant towards and onto the gears, which, when in motion, may throw the lubricant off. The lubricant may collect at the bottom of the housing, wherein the intake valve may collect the lubricant and allow it to flow into the inflow hose. The inflow hose may be connected to the pump, which may collect and pressurize the lubricant before pushing it through the outflow hose and back to a sprayer, where the cycle begins again.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A system for providing lubrication, comprising:
at least one pump configured to alter the temperature of at least one liquid pumped by the at least one pump;
at least one outflow hose coupled with at least one port on the at least one pump;
at least one sprayer coupled with the at least one outflow hose, the at least one sprayer configured to direct a liquid sprayed by the at least one sprayer to a particular location; and
at least one mounting bracket configured to couple the at least one pump with at least one gear housing, the at least one mounting bracket configured to withstand a high vibration environment.

2. The system for providing lubrication of claim 1, further comprising:
at least one inflow hose coupled with at least one port on the at least one pump; and at least one intake valve coupled with the at least one inflow hose.

3. The system for providing lubrication of claim 1, wherein the at least one sprayer is coupled with the at least one outflow hose via at least one coupler.

4. The system for providing lubrication of claim 3, wherein the at least one coupler is configured to alter a direction of flow of the lubrication.

5. The system for providing lubrication of claim 1, further comprising:
at least one gear pair, wherein the at least one sprayer is configured to spray at least some lubricant toward the at least one gear pair.

6. The system for providing lubrication of claim 5, wherein the at least one sprayer configured to spray at least some lubricant toward the at least one gear pair comprises:
at least one sprayer configured to spray at least some lubricant toward the at least one gear pair where the gears intermesh.

7. A system for providing lubrication, comprising:
at least one pump, including at least one outflow port and at least one inflow port, the at least one pump configured to alter a temperature of at least one fluid pumped by the at least one pump;
at least one outflow hose including a pump end and a sprayer end, wherein the at least one outflow hose pump end is coupled with the at least one outflow port of the at least one pump;
at least one sprayer coupled with the at least one outflow hose at the sprayer end of the at least one outflow hose, the at least one sprayer configured to direct at least one fluid to a particular location;
at least one inflow hose including a pump end and an intake end, wherein the at least one inflow hose pump end is coupled with the at least one inflow port of the at least one pump;
at least one intake valve coupled with the at least one inflow hose at the intake end of the at least one inflow hose; and
at least one mounting bracket configured to couple the at least one system with at least one gear housing.

8. The system for providing lubrication of claim 7, wherein the at least one sprayer is adjustable.

9. The system for providing lubrication of claim 7, wherein the at least one pump is adjustable.

10. The system for providing lubrication of claim 7, wherein the system is configured for circulating a lubricant through the outflow hose, the sprayer, the intake valve, the inflow hose, and the pump, and wherein the system forms a closed loop.

11. A system for providing lubrication, comprising:
at least one pump, including at least one outflow port and at least one inflow port, the at least one pump configured to alter the temperature of a fluid pumped by the at least one pump;
at least one outflow hose, including a pump end and a sprayer end, wherein the at least one outflow hose pump end is coupled with the at least one outflow port of the at least one pump;
a plurality of sprayer hoses, each hose including a pump end and a sprayer end, wherein the plurality of sprayer hose pump ends are coupled with the at least one outflow hose at the sprayer end of the at least one outflow hose;
a plurality of sprayers coupled with the plurality of sprayer hoses at the sprayer end of the plurality of sprayer hoses, wherein each of the plurality of sprayers is configured to direct the fluid pumped by the at least one pump to a particular location;
at least one inflow hose including a pump end and an intake end, wherein the at least one inflow hose pump end is coupled with the at least one inflow port of the at least one pump; and
at least one intake valve coupled with the at least one inflow hose at the intake end of the at least one inflow hose; and
at least one mounting bracket configured to couple the at least one system with at least one gear housing.

12. The system for providing lubrication of claim 11, wherein the plurality of sprayer hose pump ends coupled with the at least one outflow hose at the sprayer end of the at least one outflow hose further comprises:
at least one coupler, the at least one coupler configured to divide a single stream of liquid into at least two streams of liquid.

13. The system for providing lubrication of claim 12, wherein the at least one coupler is configured to be removably coupleable with the at least one outflow hose and the plurality of sprayer hoses.

14. The system for providing lubrication of claim 11, wherein the plurality of sprayer hose pump ends coupled with the at least one outflow hose at the sprayer end of the at least one outflow hose further comprises:
a plurality of couplers, the plurality of couplers configured to join the at least one outflow hose with the plurality of sprayer hoses.

15. The system for providing lubrication of claim 14, wherein the plurality of couplers are configured to divide a single stream of liquid into at least two streams of liquid.

16. The system for providing lubrication of claim 14, wherein the plurality of couplers are configured to be removably coupleable with the at least one outflow hose and the plurality of sprayer hoses.

17. The system for providing lubrication of claim 7, wherein the at least one mounting bracket is configured to withstand high vibration environments.

18. The system for providing lubrication of claim 7, wherein the at least one mounting bracket is configured to withstand high temperature environments.

19. The system for providing lubrication of claim 7, wherein the intake end of the at least one inflow hose is coupled with at least one reservoir, the at least one reservoir formed by at least one recess in the at least one gear housing.
